(19) United States
(12) Patent Application Publication
(10) Pub. No.: US 2018/0242629 A1
(43) Pub. Date: Aug. 30, 2018

(54) PROTEIN-COATED PRODUCT AND METHOD OF MAKING PROTEIN-COATED PRODUCT

(71) Applicant: THE HERSHEY COMPANY, Hershey, PA (US)

(72) Inventors: Julia J. WATTERSON, Hummelstown, PA (US); Julie Emsing MANN, Annville, PA (US)

(21) Appl. No.: 15/553,313

(22) PCT Filed: Feb. 26, 2016
(86) PCT No.: PCT/US2016/019816

§ 371 Date: Aug. 24, 2017

Related U.S. Application Data
(60) Provisional application No. 62/127,012, filed on Mar. 2, 2015.

(51) Int. Cl. A23P 20/10; A23L 25/00; A23L 19/00; A23G 1/54; A23G 1/30; A23L 11/00; A23L 25/10; A23G 1/44

(52) U.S. Cl. CPC A23P 20/105; A23L 25/25; A23L 19/05; A23G 1/54; A23V 2002/00; A23L 11/01; A23L 25/10; A23G 1/44; A23G 1/305

(57) ABSTRACT

In some embodiments, a protein-coated product includes an edible center and a protein-fortified coating including at least 30% by weight of protein. In some embodiments, the protein-fortified coating includes 30% to 70% by weight of protein with the protein-fortified coating being 20 to 60% by weight of the protein-coated product. A method of making a protein-coated product includes providing an edible center, preparing a syrup, preparing a dry blend including at least 30% protein, by weight, coating the edible center with alternating layers of the syrup and the dry blend to form a coated product, and modifying the coated product to form the protein-coated product.

### CROSS-REFERENCE TO RELATED APPLICATIONS

This application claims priority to and the benefit of U.S. Provisional Application No. 62/127,012 filed Mar. 2, 2015, which is hereby incorporated by reference in its entirety.

### FIELD OF THE INVENTION

This application is directed to a protein-coated product and a method of making protein-coated products. More particularly, the present invention is directed to protein coatings surrounding edible centers.

### BACKGROUND OF THE INVENTION

Confectionery and snack products are often coated with alternating layers of a sugar solution and dry sugar. One common method of coating these confectionery and snack products is through pan coating. During pan coating, a sugar solution is added to the pan and a tumbling action distributes the solution over rotating edible centers. Next, warm air is applied and/or dry powdered sugar is added to reduce the moisture content of the coating. This process is repeated until a continuous sugar coating or shell is formed around the edible centers. Typically, this coating makes up between 30% and 60% of the finished product, and is intended to provide flavor, texture, and/or heat stability. However, these sugar-based coating provide no nutritional value beyond calories.

As consumers increasingly demand snack products with better nutritional profiles, alternatives to sugar-based coatings may be desirable. One such alternative includes the use of sugar alcohols in place of sugar during pan coating. Although the sugar alcohols render a sugar-free coating for low/no sugar confections and gum, they do not provide any nutritional value to the coated products.

One known snack product has edible peanut centers pan-coated with starch and wheat flour combinations and baked to low moistures to form a crunchy coated snack. These coatings are predominately composed of carbohydrates, such as starch and sugar. These starch- and flour-based coatings also add little nutritional value beyond calories.

Another potential alternative may include coating the outside of a snack with a high-protein coating. Current methods for the formation of protein-coated snacks include the formation of filled protein dough through co-extrusion or center injection. However, bite-sized pieces formed through these methods are limited to center fill weight percentages of less than 40%. In addition, solid centers such as whole nuts or seeds would be extremely difficult to provide with these methods. Furthermore, the low water solubility of protein isolates and protein concentrates in comparison to sugars and sugar alcohols make them unlikely ingredients to be used in traditional panning processes.

Another known snack is a protein-coated snack formed by pan-coating edible centers with protein-fortified, fat-based creme, but these types of coatings have the nutritional disadvantage of adding excess fat to a product and the protein content of these coatings is generally limited to less than 20% by weight. In addition, these fat-based coatings are limited to creamy textures and cannot lead to either crunchy high-protein coatings or chewy high protein coatings. As such, to date, there have been no bite-sized snack or confectionery products identified in the marketplace having a significant amount of protein originating from a high-protein coating.

These and other drawbacks are associated with current coated products and methods used for forming coated products.

### BRIEF DESCRIPTION OF THE INVENTION

Exemplary embodiments are directed to a protein-coated product and methods of making a protein-coated product.

According to an exemplary embodiment, a protein-coated product includes an edible center and a protein-fortified coating including at least 30% by weight of protein.

According to another exemplary embodiment, a protein-coated product includes an edible center and a protein-fortified coating surrounding the edible center. The protein-fortified coating includes 30% to 70% by weight protein and this protein-fortified coating is 20 to 60% by weight of the protein-coated product, formed by alternating layers of a syrup and a dry blend including the protein.

According to another exemplary embodiment, a method of making a protein-coated product includes providing an edible center, preparing a syrup, preparing a dry blend comprising at least 30% protein, by weight, coating the edible center with alternating layers of the syrup and the dry blend to form a coated product, and modifying the coated product to form the protein-coated product.

Among the advantages of exemplary embodiments is that methods described herein may produce a comestible product including a protein-fortified snack having a better nutritional profile than existing hand-to-mouth snacks. Despite the highly nutritional coating, exemplary embodiments are capable of producing protein-coated products having greater than 40% center fill, by weight.

Another advantage is that the methods may produce protein-coated products exhibiting a variety of textures and flavors, including multi-textured products.

Still another advantage is that the methods may produce coatings providing complementary proteins to form hand-to-mouth snacks having complete proteins.

A further advantage is that the methods may provide coatings including fiber and other nutritious ingredients.

Another advantage is that the methods may form protein coatings from any type of protein.

Yet another advantage is that the methods may form a protein coating around any center having sufficient rigidity to last through the panning process.

A further advantage is that the methods may provide precise control over the amount of coating applied over the edible center of the protein-coated product.

Another advantage is that nuts and seeds coated and baked to moistures less than 4% by weight may be resistant to the onset of rancidity of the nuts and seeds.

A further advantage is that the method may provide a high protein yogurt coating.

Yet another advantage is that the method may provide a high-protein coating with yogurt containing viable probiotics.

Another advantage is that the method may provide a high-protein coating with yogurt containing a combination of viable probiotics and prebiotics.

Yet another advantage is that the method may enable the development of a high-protein vegetarian snack.

An additional advantage is that the method may enable the development of a high-protein gluten-free baked snack.

Other features and advantages of the present invention will be apparent from the following more detailed description of exemplary embodiments that illustrate, by way of example, the principles of the invention.

### DETAILED DESCRIPTION OF EXEMPLARY EMBODIMENTS

Exemplary embodiments are directed to protein-coated products and methods of making protein-coated products. Such comestibles provide a protein-fortified snack having a better nutritional profile than existing hand-to-mouth snacks. Accordingly, embodiments of the present disclosure, in comparison to methods and snacks not using one or more of the features disclosed herein, provide bite-size snacks having complete proteins, increase the protein content of bite-size snacks, increase the amount of center fill in protein-coated products, provide a method for pan coating edible centers with a protein coating, decrease the thickness of protein coatings, or a combination thereof. Unless otherwise noted, all percentages herein are weight percentages. While primarily described herein with respect to a pan coating process, it will be appreciated that the invention is not so limited and any suitable method of manufacture may be employed in addition to pan coating in which a center is alternately coated with separate syrup and dry blend layers resulting in a product having a discrete center and an outer coating, including, but not limited to, a belt coating or a drum coating. In some embodiments, a drum coating process uses a commercial coating drum, such as, for example, those available from Spray Dynamics Ltd. (St. Clair, Mo.).

Provided herein are a protein-coated product and a method of forming the protein-coated product. The protein-coated product includes an edible center surrounded by a protein-fortified coating. The edible center includes any comestible suitable for receiving the protein-fortified coating thereon. For example, suitable centers include, but are not limited to, nuts, peanuts, almonds, seeds, sunflower seeds, pumpkin seeds, legumes, pulses, crisped chickpeas, crisped lentils, fruit-based centers, vegetable-based centers, peanut butter balls, chocolate balls, gels, fruit-based gels, vegetable-based gels, fiber-enriched centers, or a combination thereof. The protein-fortified coating includes any coating having a high level of protein. As used herein, the term “high level” refers to the coating having at least 30% protein, by weight, and preferably higher, which may be achieved, for example, through the use of protein concentrates and protein isolates. Although described herein with reference to protein-fortified coatings and protein-coated products, it will be appreciated by those skilled in the art that the method is not so limited, and may be applied to any nutrient-fortified coating or nutrient-coated product, such as coatings including a high level of fiber in place of or in addition to the high level of protein.

In one embodiment, a method of forming the protein-coated product includes providing the edible center, preparing a panning syrup, preparing a dry blend, and pan coating the edible center with the panning syrup and the dry blend. In another embodiment, providing the edible center includes selecting the edible center based upon characteristics including, but not limited to, shape, size, weight, rigidity, other characteristics suitable for use in a panning process, or a combination thereof. For example, suitable shapes for the edible center may include round, substantially round, oblong, oval, other easily panned shapes, or a combination thereof. Suitable weights for the edible center include between about 50 mg and about 3 grams, such as between about 70 mg and about 3 grams, although both larger and smaller centers are possible. In a further embodiment, the edible center is selected to include a water activity of less than 0.7, which provides shelf stability to the protein-coated product.

Preparing the panning syrup includes forming an aqueous syrup having from 0% up to about 85% by weight solids. The solid content of the panning syrup is varied based upon the intended application of the product. For example, in non-bake applications, the panning syrup typically contains at least 60%, alternatively at least 65%, alternatively at least 70%, and in some embodiments between 75 and 80%, solids, by weight, although the range of solids in non-bake applications may be higher or lower. It will be appreciated that solid percentage may be adjusted based on recipe and is selected to provide syrup viscosities that distribute evenly during panning (or other coating methods as may be employed) and result in water activities that form shelf-stable products in light of the processing methods employed. A suitable water activity for shelf-stable products formed from non-bake applications includes any water activity of less than 0.7 and more preferably a water activity of 0.68 or less. To provide a suitable water activity, glycerol may also be added to the panning syrup in non-baked application.

Surprisingly, in embodiments where the edible center includes one or more components capable of becoming rancid over time, such as, for example, one or more nut components, the edible center of the protein-coated product may have a longer shelf life than the uncoated edible center in terms of time to reach rancidity. This result is surprising in that exposing a rancidity-vulnerable component to moisture, such as is experienced in the processing steps described herein, generally would be expected to increase the rancidity rate. That is, even where the moisture level of the coated edible center is similar to the moisture level of the uncoated edible center, the shelf life of the coated edible center is unexpectedly significantly better in terms of rancidity to the same edible center in an uncoated state.

Alternatively, in baked applications, the range of solids in the panning syrup may be between 35 and 55%, alternatively between 35 and 45%, alternatively about 38%, by weight, but as with the non-bake applications, the range of solids used in the syrups for baked applications may be higher or lower and is selected to facilitate syrup distribution during panning and for efficient moisture removal during baking. Due to moisture removal during baking, the water activity of the syrup during panning is of less concern and thus the solids content is typically lower.

In one embodiment, the panning syrup is a carbohydrate-based syrup. In the carbohydrate-based syrup, the solids portion includes any suitable soluble carbohydrates, such as, but not limited to, sucrose, glucose, maltose, lactose, fructose, corn syrup, corn syrup solids, rice syrup, agave syrup, tapioca syrup, or a combination thereof. In some embodiments, soluble fibers, such as polydextrose, inulin, or other suitable soluble fibers, are partially or entirely employed as the soluble carbohydrate content in the syrup. Supplementing or replacing the carbohydrate-based syrup with soluble fibers increases the nutritional profile of the final protein-coated product. Additionally, the panning syrup may include flavoring agents, such as water soluble flavors, or other additives. After adding the solids and/or any additives, the syrup is usually cooked, typically up to around 100° C. (212° F.), which can be useful to better dissolve the carbohydrate solids in forming the syrup. The syrup is then cooled to between about 21.1° C. (70° F.) and about 23.9° C. (75° F.) prior to application to the edible centers.

Preparing the dry blend includes selecting a protein and optionally mixing the protein with other ingredients, such as, but not limited to, modified starches, flours, cocoa powder, dry flavors, spices, salt, small amounts of oil, or a combination thereof. When included, the other ingredients may be selected to modify the flavor, texture, and/or color of the final product.

The dry blend typically includes between 40 and 100% by weight protein, generally added as protein concentrate or protein isolate, although lower protein amounts are contemplated depending upon the desired level of fortification. As used herein, the term “protein concentrate” includes a composition having a protein content greater than found in the natural state within the food from which it is derived. Typically, a protein concentrate has a protein content from about 40 to about 88% protein, by weight. In some embodiments, the protein concentrate includes a composition having from about 78 to about 86% protein, by weight. As used herein, the term “protein isolate” includes a composition having from about 88 to about 100% protein, by weight. In some embodiments, the protein isolate includes a composition having from about 88 to about 94% protein, by weight. Depending upon which composition is used, the dry blend, including between 40 and 100% of the concentrate and/or isolate, includes a total protein concentration of between 30 and 90%, by weight, alternatively between 30 and 80%, alternatively between 30 and 70%, alternatively between 30 and 60%, alternatively between 40 and 80%, alternatively between 40 and 70%, alternatively between 40 and 60%, or ranges or sub-ranges therebetween. Although the solubility of proteins differs from that of sugars, and proteins do not crystallize like the sugars typically used in current panning methods, it has surprisingly been discovered that dry blends formed as described above are suitable for use in pan coating processes.

Any suitable animal or vegetable protein isolate and/or concentrate may be used, including, but not limited to, soy protein, milk protein, whey protein, pea protein, rice protein, faba bean protein, peanut protein, or a combination thereof. The protein selection is dependent upon the nutrient profile of the edible center and/or the final flavor, texture, and/or ingredient tag desired. For example, in one embodiment, the selected protein includes essential amino acids that are complementary to the amino acids of the protein of the edible center. In another embodiment, the complementary protein of the coating together with the protein of the edible center provides a final product having complete proteins.

Functional properties of the protein isolates and concentrates, such as wettability, solubility, and tackiness, affect their suitability for the panning process. Some of the plant-based protein isolates/concentrates such as rice protein and pea protein are deficient in one or more of these functional properties. The functionality of dry blends containing high levels of these plant-based proteins can be improved by adding at least 5% pre-gelatinized waxy starch or high gel whey protein isolate/concentrate.

After providing the edible center, preparing a panning syrup, and/or preparing a dry blend, the pan coating includes placing the edible centers in a rotating pan, adding an initial amount of the panning syrup to the pan, and allowing the edible centers to tumble in the rotating pan until an even coating of the panning syrup is obtained around the centers. The initial amount of the panning syrup typically includes, by weight, between 1 and 2% of the total center weight, although the initial amount of the panning syrup may include, by weight, up to 5% of the total center weight. After obtaining an even coating of panning syrup over the edible centers, a portion of the dry blend is added to the rotating pan. The portion of the dry blend adheres to the surface of the panning syrup that is coating each of the edible centers. Typically, the dry blend is added at between 1 and 2% by weight of the total center weight, although more or less of the dry blend may be added. The addition of the panning syrup followed by the dry blend is then repeated one or more times to form the protein-coated product.

In one embodiment, the absolute amount of the panning syrup and/or the dry blend is dependent upon the surface area of the edible centers, and may be adjusted in each application to provide and/or maintain a smooth, even coating. For example, an increased amount of the panning syrup and/or the dry blend may be added to the rotating pan, including smaller edible centers as compared to the same total weight of larger edible centers, as the smaller edible centers include a larger surface area that takes up more of the panning syrup and the dry blend. The amount of times the addition of the panning syrup and the dry blend is repeated may vary with the size of the edible centers, the percentage of syrup and dry blend added in each dose, and/or a desired coating percentage. By adjusting the percentage of syrup and dry blend added in each dose, and/or adjusting the number of doses applied, the methods described herein provide increased control over the amount of coating added as compared to products formed through co-extrusion and/or center injection.

Exemplary embodiments are particular advantageous in producing bite-sized snacks. In some embodiments, the final product has a greatest dimension of about 2.5 cm or less, such as about 2.0 cm or less, in some cases about 1.0 cm or less. In some embodiments, the average coating thickness of the protein-coated product is in the range of 1 to 2 mm.

The desired coating percentage is dependent upon the predetermined degree of fortification, the desired final texture, and/or the desired flavor of the protein-coated product. Preferably, the coating forms between 20 and 60%, more preferably between 25 and 60%, and most preferably between 30 and 60%, by weight, of the final protein-coated product, although a higher or lower coating percentage may be formed according to the methods described herein. As will be appreciated by those skilled in the art, increasing or decreasing the percentage of the coating increases or decreases an amount of protein added to the product, respectively. For example, at a 40% by weight coating level, the protein-fortified coating adds up to 6 grams of protein and/or 4 grams of fiber to a 28-gram (1-oz.) serving of bite-sized snacks, while a greater percentage of coating may add more protein and/or fiber, and a lower percentage of coating may add less protein and/or fiber. Additionally, unlike products formed through co-extrusion and/or center injection, which are limited to a center fell of less than 40%, by weight, the methods described herein facilitate the formation of coatings of 60% or less, by weight, which provides center fill percentages of 40% or more by weight, such as, for example 45%, 50%, 55%, 60%, 65%, 70%, or any range or sub-range therebetween.

For non-baked applications, the panned pieces are then optionally coated with a finish coating such as oil, confectionery wax, and other finishing coatings and/or colorants to give the piece a finished appearance. The non-baked embodiments provide a chewy texture, which may be adjusted through the types of starch and/or sugar used in forming the product. Alternatively, for baked embodiments, the panned pieces are optionally coated with flavoring ingredients, such as, but not limited to, spice blends, salt, and/or flavors, then discharged from the rotating pan and baked to reduce moisture and/or crisp the shell to provide a crunchy texture. Additional flavors or seasonings may also be added post-bake. In some embodiments, the post-bake seasoning procedure includes introducing the coated/baked product to a rotating drum, coating with oil, preferably about 2% by weight, and then coating with a sweet or savory seasoning blend, preferably about 4% by weight. In the baked applications, the types of starch and/or sugar used may affect the expansion of the product, as does the temperature at which the product is baked. For example, high temperatures, such as 205° C. (400° F.) and higher, for shorter periods of time (e.g. 5 minutes or less) tend to provide increased expansion as compared to lower temperature baking at longer periods of time. In one embodiment, the panned pieces are baked in a rotating drum crisper, which maintains or substantially maintains a round shape of the product.

### EXAMPLES

The invention is further described in the context of the following examples which are presented by way of illustration, not of limitation. In each of Examples 1-8, the process was carried out in accordance with one or more of the embodiments disclosed herein. Table 1 summarizes the amount of protein (P) or fiber (F) as a percentage of the edible center of the product, as a percentage in the product coming from the edible center, as a percentage of the coating of the product, as a percentage in the product coming from the coating, as a total percentage in the product, all by weight, and, where applicable, as a total percentage in the seasoned product, by weight. For Examples 1, 2, 3, 4, 7, and 8, the values listed in Table 1 are for the final product. For Examples 5 and 6, the analogous values are for the product prior to the seasoning step, and the value in the last row represents the total percentage in the seasoned product after the seasoning step.

TABLE 1
Protein Content in Coated Products

| | Example | | | | | | | | | | |
|---|---|---|---|---|---|---|---|---|---|---|---|
| | 1 | 1 | 2 | 3 | 4 | 5 | 6 | 7 | 7 | 8 | 8 |
| | Ingredient | | | | | | | | | | |
| | P | F | P | P | P | P | P | P | F | P | F |
| Percent of Edible Center | 7.5 | 2.23 | 25.0 | 14.0 | 6.0 | 25.0 | 18.0 | 0 | 10.0 | 21.6 | 12.2 |
| Percent in Product from | 4.88 | 1.45 | 14.0 | 8.4 | 3.66 | 13.5 | 11.0 | 0 | 6.5 | 14.2 | 8.0 |
| Edible Center | | | | | | | | | | | |
| Percent of Coating | 37.26 | 36.72 | 52.5 | 30.14 | 42.0 | 59.0 | 50.6 | 40.0 | 21.0 | 34.0 | 20.0 |
| Percent in Product from | 13.04 | 12.85 | 23.1 | 12.06 | 16.38 | 27.1 | 19.7 | 14.0 | 7.35 | 11.6 | 6.8 |
| Coating | | | | | | | | | | | |
| Total Percent in Product | 17.9 | 14.3 | 37.1 | 20.46 | 20.0 | 40.6 | 30.7 | 14.0 | 13.85 | 25.8 | 14.8 |
| Total Percent in Seasoned | | | | | | 38.1 | 29.8 | | | | |
| Product | | | | | | | | | | | |

### Example 1

In one example, a protein-coated product in accordance with an exemplary embodiment was formed by covering an edible center with alternating layers of syrup and a dry blend. Specifically, a pumpkin-based gel including about 7% protein and 2.3% fiber by weight was drop-rolled into 1.7-gram balls to form a vegetable-based edible center.

3 kilograms of the vegetable-based edible centers were then loaded into a small rotating pan with 30 grams of syrup including 10% glycerol, 68% polydextrose (Litesse II), and 22% water. Once the edible centers were covered with the syrup, which was evidenced by their beginning to cling together, 26 grams of a dry blend including 90% soy protein isolate and 10% pumpkin spice were added to the pan. The dry blend adhered to the syrup-coated edible centers to form coated balls that began to tumble freely. The addition of the syrup followed by the dry blend was repeated until the coating comprised 35% of the coated product, by weight, resulting in a protein-coated product having an average weight of 2.61 grams. A carrot juice concentrate was then added for coloring to provide a final shelf-stable, chewy-textured, high-protein vegetable-based snack.

The edible pumpkin center, which formed 65% of the protein-coated product, by weight, included 7.5% protein and 2.23% fiber, providing 4.88% protein and 1.45% fiber to the final protein-coated product. The coating, which formed 35% of the protein-coated product, by weight, included 37.26% protein and 36.72% fiber, providing 13.04% protein and 12.85% fiber to the final protein-coated product. Specifically, the coating included 46% of the dry blend, which included 90% protein isolate, which included 90% protein, providing a total protein concentration in the coating of 37.26%. The coating also included 54% syrup, which included 68% litesse II, providing a total fiber concentration in the coating of 36.72%. The coating of the protein-coated product was a brownish-orange color and the edible center was a dark brown color.

Together, the edible pumpkin center and the protein coating provided a protein-coated product having 17.9% protein and 14.3% fiber. A 28-gram (1-oz.) serving of the high-protein vegetable snack had 5 grams of protein and 4 grams of fiber, which is considered a good source of both protein and fiber. A good source of protein, as used herein, refers to a food product providing at least 5 grams of protein per (28 to 40-gram) serving. A good source of fiber, as used herein, refers to a food product providing at least 2.5 grams of fiber per (28 to 40-gram) serving.

### Example 2

In another example, a protein-coated product in accordance with an exemplary embodiment was formed by baking a whole peanut in a shell composed of complementary proteins. The shell was formed from a 50% solids corn fiber syrup and a dry blend including 45% soy isolate, 45% whey concentrate, 5% modified corn starch, and 5% spice blend. The soy isolate and whey concentrate were selected to provide a combined amino acid profile complementary to that of peanut protein. When used in a ratio of 0.2 grams soy isolate, 0.2 grams whey concentrate, and 1 gram of peanut, the soy isolate and whey concentrate complemented the protein of the peanut. The total protein content of the dry blend was 75%, by weight.

After preparing the corn fiber syrup and the dry blend, 3 kilograms of roasted medium runner peanuts were placed in a rotating pan with 40 grams of syrup. The tumbling action provided by the rotating pan dispersed the syrup to form an even coating around each peanut center. Then 55 grams of the dry blend were added to the tumbling pan, where the dry particulates adhered to the syrup layer to coat each center. The addition of the syrup followed by the dry blend was repeated until the coating comprised about 50% of the unbaked product, by weight.

The coated peanuts were then baked in an oven at 255° C. (490° F.) for 3 minutes to puff and crisp the coating. A secondary drying step including baking the coated peanuts in an oven at 135° C. (275° F.) for 7 minutes was then optionally performed to reduce the moisture content of the coated product to less than 3%. The baking and optional drying of the coated peanuts forms the final protein-coated product with the peanut center forming about 56% of the product, by weight. The coating of the protein-coated product was a light brownish-yellow color, similar to the color of the edible center.

The peanut center, which formed 56% of the protein-coated product, by weight, included 25% protein, providing 14% protein to the final protein-coated product. The coating, which formed 44% of the protein-coated product, by weight, included 52.5% protein, providing 23.1% protein to the final protein-coated product. Together, the peanut center and the protein coating provided a protein-coated product having 37.1% by weight protein. A 28-gram (1-oz.) serving of the protein-coated snack has 10.4 grams of protein, which is considered an excellent source of protein.

Surprisingly, the baked protein shell had the added advantage of delaying the onset of rancidity in the peanut center. As shown in Table 2, uncoated roasted peanuts showed a significant increase in the aldehyde level, an indication of oil rancidity, between 4-8 weeks of storage at 40° C. (104° F.) while a similar increase in the protein-coated roasted peanuts was delayed until 20-25 weeks of storage at 40° C. (104° F.). This result was surprising in that exposing roasted peanuts to moisture generally increases rancidity rates and the moisture level of the coated and baked roasted peanuts was similar to the moisture level of the uncoated roasted peanuts, so at best, it was expected that the coated and baked roasted peanuts would have a similar shelf life in terms of rancidity to the uncoated roasted peanuts, but instead the shelf life was significantly better.

TABLE 2
Aldehyde Content in Peanuts

| | Storage Time (in weeks) | | | | | |
|---|---|---|---|---|---|---|
| | 0 | 4 | 8 | 12 | 20 | 25 |
| Aldehyde in coated peanuts (ppm) | 3 | 5 | 25 | 50 | 50 | 50 |
| Aldehyde in uncoated peanuts (ppm) | 3 | 3 | 5 | 6 | 10 | 35 |

### Example 3

In another example, a protein-coated product in accordance with an exemplary embodiment was formed by crisping a strawberry fruit puree center covered in a protein coating. The strawberry fruit puree center included 14% soy protein and was drop-rolled to form 1.5-gram balls. The protein coating was formed by pan coating the edible center with alternating layers of syrup and a dry blend. The syrup included 25% sucrose, 31% 42 DE tapioca syrup, 44% water, and 0.1% strawberry flavor. The dry blend included 43% protein, by weight, and was formed by dry blending 21% pea protein concentrate, 14% rice protein isolate, 25% defatted peanut flour, 39% pre-gelatinized modified corn starch, and 1% sugar cookie flavor. After preparing the syrup and the dry blend, 3 kilograms of the edible fruit centers were placed in a rotating pan with 30 grams of syrup. The tumbling action provided by the rotating pan dispersed the syrup to form an even coating around each edible fruit center. Then 40 grams of the dry blend were added to the tumbling pan, where the dry particulates adhered to the syrup layer to coat each center. The addition of the syrup followed by the dry blend was repeated until each of the centers weighed about 2.8 grams, which corresponds to the coating forming about 46% of the unbaked product, by weight.

The panned balls were then sent through a tumbling crisper at 255° C. (490° F.) to drive moisture from the coating and expand the starch. The crisped and expanded balls were then put through a drying oven at 135° C. (275° F.) for 5 minutes to reduce the moisture content to less than 3%. After baking, the fruit centers formed about 60% of the product, by weight. The coating of the protein-coated product was a light brownish-yellow color and the edible center was a dark almost black color.

The edible center, which formed 60% of the protein-coated product, by weight, included 14% protein, providing 8.4% protein to the final protein-coated product. The coating, which formed 40% of the protein-coated product, by weight, includes 30.14% protein (70% dry blend having 43% protein), providing 12.06% protein to the final protein-coated product. Together, the strawberry center and the protein coating form the protein-coated product having 20.46% protein. A 28-gram (1-oz.) serving of the protein-coated snack had 5.73 grams of protein, which is considered a good source of protein.

### Example 4

In another example, a protein-coated product in accordance with an exemplary embodiment was formed by crisping milk chocolate covered in a protein coating. The milk chocolate center included 6% protein, by weight, and was tempered and then drop-rolled to form 1.6-gram round centers. The protein coating was formed from pan coating the milk chocolate center with alternating layers of syrup and a dry blend. The syrup included 50% sucrose. The dry blend included 60% protein, by weight, and was formed by dry blending 67% whey protein isolate, 20% modified corn starch, and 13% rice flour.

After preparing the syrup and the dry blend, 3 kilograms of the milk chocolate centers were placed in a rotating pan with 30 grams of syrup. The tumbling action provided by the rotating pan dispersed the syrup to form an even coating around each edible fruit center. Then 40 grams of the dry blend were added to the tumbling pan, where the dry particulates adhered to the syrup layer to coat each center. The addition of the syrup followed by the dry blend was repeated until each of the centers weighed about 2.8 grams, which corresponds to the coating forming about 44% of the unbaked product, by weight.

The panned balls were then sent through a tumbling crisper at 255° C. (490° F.) to drive moisture from the coating and expand the starch. The crisped and expanded balls were then put through a drying oven at 135° C. (275° F.) for 5 minutes to reduce the moisture content to less than 3%. After baking, the milk chocolate centers formed about 61% of the product, by weight. The coating of the protein-coated product was a light brownish-yellow color and the edible center was a dark brown color.

The edible center, which formed 61% of the protein-coated product, by weight, included 6% protein, providing 3.66% protein to the final protein-coated product. The coating, which formed 39% of the protein-coated product, by weight, included 42% protein (70% dry blend having 60% protein), providing 16.38% protein to the final protein-coated product. Together, the chocolate center and the protein coating formed the protein-coated product having 20% protein, by weight. A 28-gram (1-oz.) serving of the protein-coated snack had about 5.5 grams of protein, which is considered a good source of protein.

### Example 5

In another example, a protein-coated product in accordance with an exemplary embodiment was formed by baking a roasted sunflower seed in a shell composed of complementary proteins. The shell was formed from a 38% solids sucrose syrup and a dry blend including 60% soy isolate, 35% whey concentrate, and 5% sunflower oil. The soy isolate and whey concentrate were selected to provide a combined amino acid profile complementary to that of sunflower protein. The total protein content of the dry blend was 80%, by weight.

After preparing the sucrose syrup and the dry blend, 3 kilograms of roasted sunflower seeds were placed in a rotating pan with 47 grams of syrup. The tumbling action provided by the rotating pan dispersed the syrup to form an even coating around each sunflower seed center. Then 53 grams of the dry blend were added to the tumbling pan, where the dry particulates adhered to the syrup layer to coat each center. The addition of the syrup followed by the dry blend was repeated until the coating comprised about 55% of the unbaked product, by weight.

The coated sunflower seeds were then baked in an oven at 218° C. (425° F.) for 4 minutes to puff and crisp the coating. A secondary drying step, including baking the coated sunflower seeds in an oven at 135° C. (275° F.) for 8 minutes, was then optionally performed to reduce the moisture content of the coated product to less than 3%. The baking and optional drying of the coated sunflower seeds formed the unflavored protein-coated product with the sunflower seed center forming about 54% of the product, by weight.

The sunflower seed center, which formed 54% of the protein-coated product, by weight, included 25% protein, providing 13.5% protein to the final protein-coated product. The coating, which formed 46% of the protein-coated product, by weight, included 59% protein, providing 27.1% protein to the final protein-coated product. Together, the sunflower seed center and the protein coating provided the unflavored protein-coated product having 40.6% protein, by weight. After baking, the product was then seasoned by coating with 2% oil followed by 4% savory butter seasoning, resulting in a final product containing 38.1% protein, by weight. A 28-gram (1-oz.) serving of the protein-coated snack had 10.6 grams of protein, which is considered an excellent source of protein. The coating of the protein-coated product was a light brownish-yellow color, similar to the color of the edible center.

### Example 6

In another example, a protein-coated product in accordance with an exemplary embodiment was formed by baking a roasted chickpea in a shell composed of plant-based proteins. The shell was formed from a 15% solids sucrose syrup and a dry blend including 70% pea protein isolate and 30% pre-gelatinized waxy corn starch. The total protein content of the dry blend was 60%, by weight.

After preparing the sucrose syrup and the dry blend, 3 kilograms of roasted chickpeas were placed in a rotating pan with 55 grams of syrup. The tumbling action provided by the rotating pan dispersed the syrup to form an even coating around each chickpea center. Then 45 grams of the dry blend were added to the tumbling pan, where the dry particulates adhered to the syrup layer to coat each center. The addition of the syrup followed by the dry blend was repeated until the coating comprised about 55% of the unbaked product, by weight.

The coated chickpeas were then baked in an oven at 218° C. (425° F.) for 5 minutes to puff and crisp the coating. A secondary drying step, including baking the coated chickpeas in an oven at 135° C. (275° F.) for 25 minutes, was then optionally performed to reduce the moisture content of the coated product to less than 3%. The baking and optional drying of the coated chickpeas formed the unflavored protein-coated product with the chickpea center forming about 61% of the product, by weight.

The chickpea center, which formed 61% of the protein-coated product, by weight, included 18% protein, providing 11% protein to the final protein-coated product. The coating, which formed 39% of the protein-coated product, by weight, included 50.6% protein, providing 19.7% protein to the final protein-coated product. Together, the chickpea center and the protein coating provided the unflavored protein-coated product with 30.7% protein, by weight. After baking, the product was then seasoned by coating with 2% oil followed by 1% sea salt, resulting in a final product containing 29.8% protein, by weight. A 35-gram (1.2-oz.) serving of the plant-based, protein-coated snack had 10.4 grams of protein, which is considered an excellent source of protein. The coating of the protein-coated product was a light brownish-yellow color, but darker than the color of the edible center.

### Example 7

In another example, a high-protein, yogurt-coated product in accordance with an exemplary embodiment was formed by covering an edible center with alternating layers of syrup and a dry blend. Specifically, an apple and pear puree-based gel including about 10% fiber by weight was rolled into a 1-cm high sheet and then cut into squares to form a fruit and fiber-based edible center.

3 kilograms of the fruit and fiber-based edible centers were then loaded into a small rotating pan with 25 grams of syrup including 30% glycerol, 69.8% inulin syrup (67% fiber), and 0.2% dairy crème flavor. Once the edible centers were covered with the syrup, which was evidenced by their beginning to cling together, 31 grams of a dry blend including 45% soy protein isolate, 30% yogurt powder, 15% whey protein isolate, 5% strawberry powder, and 5% BC 30 probiotics (Ganeden Biotech, Mayfield Heights, Ohio) were added to the pan. The dry blend adhered to the syrup-coated edible centers to form coated pieces that began to tumble freely. The addition of the syrup followed by the dry blend was repeated until the coating comprised 35% of the coated product, by weight, resulting in a dual-textured fruit and yogurt snack with high protein, prebiotic fiber, and active probiotics weighing 2.61 grams per piece. The edible center retained its cubic shape in the protein-coated product. The coating of the protein-coated product was a very light brownish-yellow color and the edible center was a dark brown color.

The edible fruit and fiber center, which formed 65% of the protein-coated product, by weight, included 10% fiber, providing 6.5% fiber to the final protein-coated product. The coating, which formed 35% of the protein-coated product, by weight, included 40% protein and 21% fiber, providing 14% protein and 13.85% fiber to the final coated product. A 40-gram (1.4-oz.) serving of this fruit and yogurt snack contained 5.6 grams of protein and 5.5 grams of fiber, which is considered a good source of protein and an excellent source of prebiotic fiber. This snack also had the benefit of active probiotics.

### Example 8

In another example, a protein and fiber-coated product in accordance with an exemplary embodiment was formed by baking a peanut butter creme center in a shell composed of whey protein and pea fiber. The peanut butter center was composed of 38.5% ground peanuts, 24% peanut flour, 18% cocoa butter, 19% 6× sugar, and 0.5% salt. This peanut mass was formed into 1.7-gram ball-shaped centers by drop rolling. The total protein and fiber content of the peanut butter center was 21.6% and 12.2%, respectively. The shell was formed from a 50% solids sucrose syrup and a dry blend including 60% whey protein concentrate and 40% pea fiber ingredient, which was 70% fiber by weight. The total protein and fiber content of the dry blend was 48% and 28%, respectively.

After preparing the sucrose syrup and the dry blend, 3 kilograms of peanut butter centers were placed in a rotating pan with 45 grams of syrup. The tumbling action provided by the rotating pan dispersed the syrup to form an even coating around each peanut butter center. Then 55 grams of the dry blend were then added to the tumbling pan, where the dry particulates adhered to the syrup layer to coat each center. The addition of the syrup followed by the dry blend was repeated until the coating comprised about 40% of the unbaked product, by weight.

The coated peanut butter centers were then crisped in a rotary crisper set at 232° C. (450° F.) and 7 RPM drum speed to 2.5% moisture. The resulting protein and fiber-coated product contained about 66% peanut butter center. The coating of the protein-coated product was a brownish-yellow color, similar to the color of the edible center.

The peanut butter center, which formed 66% of the protein and fiber-coated product, by weight, included 21.6% protein and 12.2% fiber, providing 14.2% protein and 8% fiber to the final protein-coated product. The coating, which formed 34% of the protein-coated product, by weight, included 34% protein and 20% fiber, providing 11.6% protein and 6.8% fiber to the final protein and fiber-coated product. Together, the peanut butter center and the protein and fiber coating formed a final protein and fiber-coated product having 23.8% protein and 16.4% fiber, by weight. A 35-gram (1.2-oz.) serving of this protein and fiber-coated snack had 9 grams of protein and 5.2 grams of dietary fiber, which is considered to be both a good source of protein and an excellent source of fiber. An excellent source of fiber, as used herein, refers to a food product providing at least 5 grams of fiber per (28 to 40-gram) serving.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1: A method of forming a dissolvable unit dose construct comprising:
providing a first composition comprising a water soluble polymer and a liquid carrier;
depositing the first composition onto a substrate;
providing a second composition comprising a water soluble polymer and a liquid carrier;
applying the second composition at a discrete location overlying the first composition by microdeposition; and
removing at least a portion of the liquid carrier from the first composition to form a unit dose construct.

2. (canceled)

3: The method of claim 1, comprising forming a first unit dose construct and thereafter forming a second unit dose construct, wherein the first unit dose construct contains a volume of the second composition greater than the second unit dose construct.

4: The method of claim 3, wherein the first and second individual units contain a same volume of the first composition.

5: The method of claim 3, wherein the first and second compositions are formed as films.

6: The method of claim 1, comprising depositing the first composition on the substrate as individual units.

7: The method of claim 1, wherein the second composition further comprises an active ingredient.

8: The method of claim 1, wherein the first composition further comprises an active ingredient.

9: The method of claim 1, further comprising
providing a third composition comprising a water soluble polymer and a liquid carrier;
depositing the third composition overlying a portion of the first composition,
wherein a first unit dose construct comprises the first and second compositions and a second unit dose construct comprises the first and third compositions.

10: The method of claim 9, wherein the first individual unit dose construct consists of the first and second compositions and the second individual unit dose construct consists of the first and third compositions.

11: The method of claim 1, further comprising
providing a third composition comprising a water soluble polymer and a liquid carrier; and
depositing the third composition overlying a portion of the first composition at a location discrete from the location of the applied second composition, such that a single unit dose construct comprises each of the first, second and third compositions.
